(19) United States
(12) Patent Application Publication
(10) Pub. No.: US 2026/0200743 A1
(43) Pub. Date: Jul. 16, 2026

(54) GRAPHITE PRODUCTION FROM CARBON DIOXIDE

(71) Applicant: Southwest Research Institute, San Antonio, TX (US)

(72) Inventor: Josh MANGUM, Sarasota, FL (US)

(21) Appl. No.: 19/443,699

(22) Filed: Jan. 8, 2026

Related U.S. Application Data
(60) Provisional application No. 63/743,996, filed on Jan. 10, 2025.

(51) Int. Cl. C01B 32/205; B01J 19/08

(52) U.S. Cl. CPC C01B 32/205; B01J 19/088; B01J 2219/0896

(57) ABSTRACT

An apparatus and process for graphite production from carbon dioxide. The process employs a plasma reactor assembly system providing conditions to convert carbon dioxide into graphite. The graphite output from the plasma reactor can be conveniently recovered in a solid recovery device. Any oxygen that is output from the plasma reactor may be subject to combustion and formation of additional carbon dioxide for cycling back into the plasma reactor.

### FIELD

The present invention is directed at an apparatus and process for graphite production from carbon dioxide. The process employs a plasma reactor assembly system providing conditions to convert carbon dioxide into graphite.

### BACKGROUND

Carbon dioxide (CO₂) emissions continue to drive global climate change, creating an urgent need for carbon capture and utilization technologies. While existing technologies can capture CO₂ from air or industrial emissions, the challenge lies in what to do with the captured CO₂. Current approaches face relatively significant barriers in both storage and conversion pathways.

Underground storage of CO₂ requires transportation to geological formations or abandoned oil wells. This approach demands relatively massive infrastructure investment, estimated at over $100 billion, for CO₂ pipelines that do not currently exist at the required scale. The construction of this infrastructure presents substantial logistical, financial, and regulatory challenges.

Chemical conversion of CO₂ to commodity products like methanol, methane, and sustainable aviation fuel uses established processes such as hydrogenation and Fischer-Tropsch synthesis. However, the relatively low market prices for these products, ranging from $300 to $1,600 per ton, make conversion unprofitable without government subsidies. Furthermore, many of these converted products eventually release CO₂ back into the atmosphere, failing to achieve permanent carbon sequestration.

Accordingly, a need remains to identify new methodologies that would otherwise allow for consumption of CO₂ emissions and conversion of CO₂ in such emissions to more useful secondary type products.

### SUMMARY

A method for converting carbon dioxide to graphite comprising supplying a plasma reactor and introducing carbon dioxide into the plasma reactor at a pressure in the range of 1 bar to 80 bar. One then forms a plasma having a temperature of less than or equal to 200 °C at an electron density in the range of about 10¹⁰ to 10²⁰ electrons/cm³. The carbon dioxide in the plasma reactor can then be converted into graphite.

A method for converting carbon dioxide to graphite comprising: supplying a plasma reactor and introducing carbon dioxide into said plasma reactor at a pressure in the range of 1 bar to 80 bar. One then forms a plasma having a temperature of less than or 200 °C at an electron density in the range of about 10¹⁰ to 10²⁰ electrons/cm³. The carbon dioxide in the plasma can then be converted into graphite. The graphite is then output to a solids recovery device along with oxygen which solids recovery device separates said graphite from the oxygen. The oxygen in the solids recovery device is directed to a combustor which forms carbon dioxide which carbon dioxide from said combustor is introduced into said plasma reactor.

A plasma apparatus for conversion of carbon dioxide to graphite comprising a compressor to deliver carbon dioxide to a plasma reactor at a pressure in the range of 1 bar to 80 bar, a plasma reactor that forms a plasma at a temperature of less than or equal to 200 °C at an electron density in the range of 10¹⁰ to 10²⁰ electrons/cm³ and wherein the plasma reactor converts carbon dioxide into graphite and outputs graphite to a solids recovery device that recovers solid graphite.

### BRIEF DESCRIPTION OF THE DRAWINGS

FIG. 1 shows one preferred plasma system for conversion of carbon dioxide to graphite.

### DETAILED DESCRIPTION

The present invention provides a plasma reactor assembly system for converting CO₂ to graphite. The plasma system employs a plasma reactor design that seeks to optimize energy efficiency and CO₂ conversion while minimizing unwanted side reactions. The plasma system preferably utilizes a relatively low temperature plasma of less than or equal to 200 °C (< 200 °C) more preferably in the range of 25 °C to 200 °C, and in an even more preferable embodiment, 25° C to 100°C. The aforementioned temperature ranges include all values and increments therein. The electron density of the plasma is preferably in the range of 10¹⁰ to 10²⁰ electrons/cm³, more preferably 10¹⁸ to 10²² electron/cm³. The aforementioned electron density range also includes all values and increments therein. Such plasma conditions are preferred to therefore promote the break of CO₂ bonds and also to reduce or prevent a reaction of solid carbon and oxygen to form carbon monoxide. Accordingly, such temperatures and electron density characteristics are contemplated to provide relatively high product yields of graphite and reduction in the loss of carbon product.

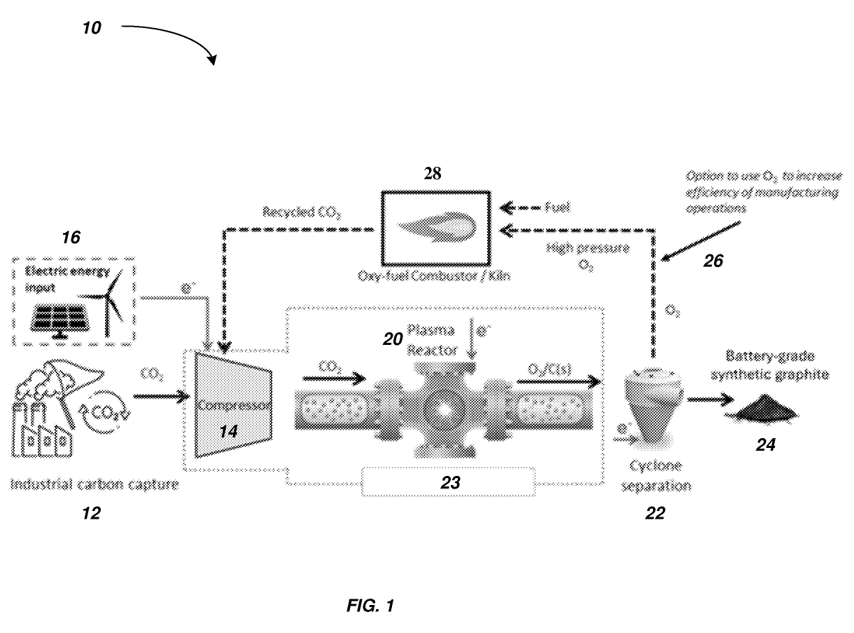

FIG. 1 illustrates one preferred plasma reactor assembly system 10 for the conversion of CO₂to graphite. As can be observed, at 12 the system preferably relies upon the capture of CO₂ from the air or industrial sources which is preferably directed to a compressor 14 powered by electrical energy 16. The CO₂ is then preferably compressed to pressure in the range of 1 bar to 80 bar, and more preferably 15 bar to 75 bar, or 40 bar to 75 bar, including all values and increments therein. The compressed CO₂ is then preferably routed to the plasma reactor 20. As noted above, such plasma reactor preferably operates at a temperature of < 200 °C and provides an electron density of the applied plasma in the range of 10¹⁰ to 10²⁰ electrons/cm³.

In addition, the plasma reactor 20 preferably provides a pulsed DC power delivery at 500 V to 20kV, more preferably 2000 V to 8000 V, including all values and increments therein. The pulse width is preferably 5 nanoseconds to 20 microseconds. The frequency of the applied pulse is preferably in the range of 500 Hz to 100,000 Hz, including all values and increments therein.

Moreover, the plasma reactor also preferably provides pulsed AC power with discharge voltages from 2kV to 40 kV, with a discharge frequency of 100 Hz to 3000 Hz and a pulse width of 8 microseconds to 825 microseconds.

Item 23 identifies the central components of the plasma reactor system 10, namely the compressor 14 and plasma reactor 20 noted herein, and the relative flow pathway for introduction of CO_{2,} the DC power delivery and the output of solid carbon (Cs) in the form of graphite as well as oxygen (O₂).

As further illustrated in FIG. 1, preferably, the plasma reactor assembly system 10 outputs to a solid recovery device, such as a cyclone separator 22 for the recovery of solid graphite at 24. The solids recovery device (e.g., a cyclone separator) may be understood as a device that utilizes centrifugal force to separate solid particles (i.e. graphite) from the output of the plasma reactor gas flow, which graphite particles can be preferably spiraled down to a collection hopper. In addition, unutilized O₂ may be recycled at 26 to optimize the use of the plasma reactor system 10 and may be introduced into an oxy-fuel combustor to generate heat and additional amounts of CO₂for cycling back into the plasma reactor system.

It is also worth noting that the plasma reactor assembly system 10 is itself preferably designed to withstand pressures up to 200 bar. Within the subject plasma reactor 20, the pressurized feedstock of CO₂ gas passes through the electrode zone of the plasma reactor, where it is exposed to the pulsed DC noted above, that facilitates the chemical conversion of CO₂ into graphite and oxygen gas. Without being bound by theory, it is contemplated that by operating at temperatures at or below 200°C, the plasma reactor now achieves CO₂ dissociation through vibrational excitation and direct electron impact dissociation while maintaining temperatures low enough to suppress carbon monoxide formation. The electrode materials for application of the pulsed DC voltage noted herein preferably include catalytically active metals such as copper, iron, and nickel. It should also be appreciated that to optimize feedstock CO₂gas interaction with the plasma and improve conversion efficiency, the plasma reactor 10 preferably can incorporate a plurality of flow channels and plasma generation sites.

The plasma system herein for conversion of CO₂ to graphite may offer one or more advantages stemming from its plasma operating characteristics. Operation of pressures of 1 bar to 80 bar is further contemplated to allow for both the formation of shockwaves during plasma pulses and the creation of the plasma with an electron density in the range of 10¹⁰ to 10²⁰ electrons/cm³. As alluded to above, this is contemplated to provide for relatively efficient CO₂ molecular excitation and dissociation while minimizing energy requirements. Operation at temperature of < 200 °C are further contemplated to not only reduce or prevent carbon monoxide formation but also minimizes thermal losses commonly associated with relatively high-temperature systems.

It is also worth noting that the plasma system herein is contemplated to be scalable and can be assembled utilizing commercially available components for compression and the plasma reaction processes. The modular design illustrated in the preferred configured illustrated in FIG. 1 is contemplated to allow for installation at the point of CO₂ capture, eliminating the need for storage or transportation infrastructure. Furthermore, it is contemplated that the plasma process described herein can produce nanoscale and nanocrystalline graphite particularly suited for battery anode materials, where such materials have demonstrated improvements in battery performance and longevity.

The above described conversion of CO₂ into graphite is therefore contemplated to offer relatively higher market value than traditional conversion products while achieving relatively permanent carbon sequestration in a stable, useful form. The conversion of CO₂ herein to graphite also may address critical supply chain vulnerabilities. This may be especially important as the United States has designated graphite as a critical mineral for domestic use. Additionally, CO₂-derived graphite is contemplated to provide a relatively environmentally superior alternative to both mining natural graphite and producing synthetic graphite from petroleum coke.

What is claimed is:

1. A method for converting carbon dioxide to graphite comprising:
supplying a plasma reactor and introducing carbon dioxide into said plasma reactor at a pressure in the range of 1 bar to 80 bar;
forming a plasma having a temperature of less than or 200 °C at an electron density in the range of about 10¹⁰ to 10²⁰ electrons/cm³; and
converting said carbon dioxide into graphite.

2. The method of claim 1, wherein said carbon dioxide is introduced into said plasma reactor at a pressure in the range of 15 bar to 75 bar.

3. The method of claim 1, wherein said plasma temperature is in the range of 25 °C to 200 °C.

4. The method of claim 1, wherein said plasma temperature is in the range of 25 °C to 100 °C.

5. The method of claim 1, wherein said electron density is in the range of 10¹⁸ to 10²⁰ electrons/cm³.

6. The method of claim 1, wherein said plasma is formed by application of a pulsed DC at a voltage of 500 V to 20kV, at a pulse width of 5 nanoseconds to 20 microseconds, and at a pulse frequency of 500 Hz to 100,000 Hz.

7. The method of claim 1, wherein said plasma is formed by application of pulsed AC with discharge voltages from 2kV to 40 kV, a discharge frequency of 100 Hz to 3000 Hz and a pulse width of 8 microseconds to 825 microseconds.

8. The method of claim 1, wherein said plasma reactor plasma reactor outputs said graphite to a solids recovery device along with oxygen which solids recovery device separates said graphite from said oxygen.

9. The method of claim 8, wherein said oxygen in said solids recovery device is directed to a combustor which forms carbon dioxide which carbon dioxide from said combustor is introduced into said plasma reactor.

10. A method for converting carbon dioxide to graphite comprising:
supplying a plasma reactor and introducing carbon dioxide into said plasma reactor at a pressure in the range of 1 bar to 80 bar;
forming a plasma having a temperature of less than or 200 °C at an electron density in the range of about 10¹⁰ to 10²⁰ electrons/cm³;
converting said carbon dioxide into graphite;
outputting said graphite to a solids recovery device along with oxygen which solids recovery device separates said graphite from said oxygen;
said oxygen in said solids recovery device is directed to a combustor which forms carbon dioxide which carbon dioxide from said combustor is introduced into said plasma reactor.

11. The method of claim 10, wherein said carbon dioxide is introduced into said plasma reactor at a pressure in the range of 15 bar to 75 bar.

12. The method of claim 10, wherein said plasma temperature is in the range of 25 °C to 200 °C.

13. The method of claim 10, wherein said plasma temperature is in the range of 25 °C to 100 °C.

14. The method of claim 10, wherein said electron density is in the range of 10¹⁸ to 10²⁰ electrons/cm³.

15. The method of claim 10, wherein said plasma is formed by application of a pulsed DC at a voltage of 500 V to 20kV, at a pulse width of 5 nanoseconds to 20 microseconds, and at a pulse frequency of 500 Hz to 100,000 Hz.

16. The method of claim 10, wherein said plasma is formed by application of pulsed AC pulsed AC with discharge voltages from 2kV to 40 kV, a discharge frequency of 100 Hz to 3000 Hz and a pulse width of 8 microseconds to 825 microseconds.

17. A plasma apparatus for conversion of carbon dioxide to graphite comprising a compressor to deliver carbon dioxide to a plasma reactor at a pressure in the range of 1 bar to 80 bar, a plasma reactor that forms a plasma at a temperature of less than or equal to 200 °C at an electron density in the range of about 10¹⁰ to 10²⁰ electrons/cm³ and wherein said plasma reactor converts carbon dioxide into graphite and wherein said plasma reactor outputs graphite to a solids recovery device that recovers solid graphite.

18. The plasma apparatus of claim 17, wherein said plasma reactor outputs graphite and oxygen to said solids recovery device and said oxygen in said solids recovery device is directed to a combustor which forms carbon dioxide which carbon dioxide from said combustor is directed into said plasma reactor.

19. The plasma apparatus of claim 17, wherein said plasma temperature is in the range of 25 °C to 200 °C.

20. The plasma apparatus of claim 17, wherein said plasma is formed by application of a pulsed DC at a voltage of 500 V to 20kV, at a pulse width of 5 nanoseconds to 20 microseconds, and at a pulse frequency of 500 Hz to 100,000 Hz.

21. The plasma apparatus of claim 17, wherein said plasma is formed by application of pulsed AC with discharge voltages from 2kV to 40 kV, a discharge frequency of 100 Hz to 3000 Hz and a pulse width of 8 microseconds to 825 microseconds.
